(19) United States
(12) Patent Application Publication
(10) Pub. No.: US 2006/0193945 A1
(43) Pub. Date: Aug. 31, 2006

(54) Stabilization of oxidized fats

(75) Inventors: Bob J. Dull, Akron, OH (US); Krystyna Kawabata, Naperville, IL (US); James G. Hawkes, Chicago, IL (US); Jim G. Fotos, Westmont, IL (US); Zulin Shi, Naperville, IL (US)

Correspondence Address: SYNNESTVEDT LECHNER & WOODBRIDGE LLP, P O BOX 592, PRINCETON, NJ, 08542-0592, US

(73) Assignee: NuSci Laboratories, Fairlawn, OH (US)

(21) Appl. No.: 11/385,343

(22) Filed: Mar. 21, 2006

Related U.S. Application Data
(60) Provisional application No. 60/692,035, filed on Jun. 17, 2005.

(51) Int. Cl. A23K 1/18

(52) U.S. Cl. 426/2

(57) ABSTRACT

A method for improving the palatability of a livestock feed or companion animal food product comprising a basal composition containing unsaturated fatty acids that oxidize to form aldehydes or ketones by contacting the basal composition with a source of bisulfite anions so that any aldehydes or ketones present form organosulfite salts. Bisulfite-treated livestock feed and companion animal food products, and palatability enhancing composition containing a source of bisulfite anions are also disclosed.

### CROSS-REFERENCE TO RELATED APPLICATIONS

This application claims priority under 35 U.S.C. § 119(e) to U.S. Provisional Application Ser. No. 60/692,035, which was filed on Jun. 17, 2005, the disclosure of which is incorporated herein by reference.

### BACKGROUND OF THE INVENTION

This invention generally relates to a method for improving the palatability of a livestock feed or companion animal food product containing a fat or oil that has oxidized. In particular, the present invention relates to improving the palatability of livestock feeds and companion animal food products containing unsaturated fatty acids that oxidize to form aldehydes and ketones by mixing or coating the feed or food product with a source of bisulfite anions.

Animal feed manufacturers and pet food manufacturers have a long-standing desire to provide foods that combine high nutritional value, and resistance to decomposition and bacterial contamination, with low production costs. In addition, animal feed and pet food manufacturers desire a high degree of palatability that can be attained at low cost.

The use of raw materials such as feed-grade meat and meat by-products and animal fats and oils and vegetable oils is common in the manufacture of livestock feed and food products for companion animals. Storage conditions, time, temperature and the like all take their toll on stability of the finished products and their eventual value as feed and companion animal food. This is accelerated by the practice of not using sufficient anti-oxidants in oxidation-sensitive materials.

The popularity of high quality companion animal food products has led to consumption of better quality ingredients by this segment of the industry, leaving more lower quality ingredients available at appropriate cost for the manufacturers of less expensive food and feed products. Lower cost ingredients typically start with a negative palatability value and contain flavors and odors as a result of oxidation that work against palatability. The degree of negative palatability value varies from batch to batch.

The nutritional value of the meat, oil and fat raw materials is a critical factor, but so is that of palatability. Product oxidation can significantly impact palatability long before there is a negative impact upon nutritional value. Companion animals in particular are notoriously fickle in their food preferences.

The condition known as rancidity can negatively impact the palatability of fat- and oil-containing livestock feed and companion animal food raw materials long before there is a negative impact upon nutritional value. Rancidity in meat and meat by-products, as well as in animal fats and oils and vegetable oils, is the result of natural and ongoing oxidative processes that result in the formation of compounds that are very negative to palatability. The impact is not mitigated by application of a palatability enhancing composition. In studies, dogs that are initially attracted to a test sample of dog food containing a palatability enhancer are repulsed upon closer inspection if the sample contains a rancid fat or oil component.

In particular, the oxidation of unsaturated fatty acids is a major contributor to the formation of hexanal, the product of the partial oxidation of alcohol groups. These alcohol groups arise from the natural oxidation of polyunsaturated fats and oils. This is a process that can be monitored by the formation of peroxides and evaluated through the measurement of peroxide values (PV).

In the normal course of oxidation, the unsaturated carbon-carbon bond of an unsaturated fatty acid is attacked by oxygen, resulting in the formation of peroxides. The peroxides, after several additional steps, form aldehydes and ketones of various chain lengths. Aldehydes of importance include pentanal, hexanal and heptanal. The aldehyde of particular interest is that of hexanal as it is a well known flavor compound that is a negative palatant to many animals, including dogs and cats.

At present, unsaturated fatty acid-containing feed- and food-grade raw materials must be discarded if aldehyde and ketone levels are sufficient to have a negative impact on palatability, even if nutritional value has not been affected. To do otherwise, risks the result-ing product gaining a negative reputation among purchasers. Thus, considerable cost savings can be attained if a means by which objectionable aldehydes and ketones could be removed were available so nutritious raw materials that would otherwise be discarded could be used.

The oxidation of unsaturated fatty acids to form aldehydes such as pentanal, hexanal and heptanal is also a problem in the manufacture and preparation of food products for human consumption. One example is the cooking oil in which foods are fried. Cooking oils rapidly oxidize to form objectionable aldehydes and ketones, which impact negatively on palatability by detracting from flavor and other organoleptic properties. Commercial food manufacturers and eating establishments must frequently replace otherwise good cooking oil because small quantities of aldehydes and ketones form in levels sufficient to result in a food product that is generally unacceptable to the consuming public. Considerable cost savings could be attained if a means by which such cooking oil could be reclaimed was available.

Accordingly, a need exists for a method by which aldehydes and ketones can be removed from oxidized unsaturated fatty acids.

### SUMMARY OF THE INVENTION

This need is met by the present invention. It has now been discovered that the well-described pathway for converting aldehydes and ketones with bisulfites to organosulfite salts can be adapted to convert volatile aldehydes and ketones to non-volatile organosulfites in livestock feed and companion animal food products containing oxidized unsaturated fatty acids, thereby overcoming a major hurdle to improving the palatability of the livestock feed and companion animal food products.

Therefore, according to one aspect of the present invention, a method is provided for improving the palatability of a livestock feed or companion animal food product in which the basal composition contains unsaturated fatty acids that oxidize to form aldehydes or ketones, wherein the basal composition is contacted with a source of bisulfite anions so that any aldehydes or ketones present form water-soluble organosulfite salts. The organosulfite salts form under aqueous conditions from bisulfite anions that may be generated, for example, by the dissociation of metabisulfite species in water. Thus, sources of bisulfite anions include dry metabisulfite species and aqueous bisulfite solutions wherein the bisulfite is hydrated.

Accordingly, bisulfite anions may be provided by adding a dry metabisufite species to a moisture-containing basal composition or an aqueous bisulfite solution may be contacted with a dry or moisture-containing basal composition. Typically, metabisulfite species may be added or applied dry to the basal composition when enough water is present in the basal composition for bisulfite anions to form. When insufficient water is present, an aqueous bisulfite solution is applied or added, typically to an extruded kibble.

While a solution can also be applied or added to moisture-containing basal compositions, this is disfavored because of the energy costs associated with drying excess moisture from such products. Methods according to the present invention can be performed as a batch or continuous process.

According to one embodiment of this aspect of the invention, when the basal composition is extruded to form a dry or semi-dry kibble the basal composition may be contacted with the bisulfite anion source either before or after the kibble is extruded. When the basal composition is contacted with the bisulfite anion source after the kibble is extruded, an aqueous bisulfite solution is applied to the kibble surface. According to another embodiment of this aspect of the invention, a palatability enhancing composition is applied to the kibble surface either before or after contacting the basal composition with the bisulfite solution.

When the companion animal food product is a cooked moist product, the basal composition may be contacted with the bisulfite anion source either prior to or after cooking. Contact prior to cooking is preferred for production efficiency. Therefore, according to another embodiment of this aspect of the invention, a method is provided for improving the palatability of a cooked moist companion animal food product containing unsaturated fatty acids that oxidize to form aldehydes or ketones, in which the food product is contacted prior to cooking with a source of bisulfite anions so that any aldehydes or ketones present form organosulfite salts. Typically, dry metabisulfite salts are added to moist products.

One embodiment of this aspect of the invention treats the food product raw materials containing unsaturated fatty acids before the raw materials are added to the food product. The present invention therefore also provides a method in which the bisulfite anion source is contacted with the food product prior to cooking by contacting the bisulfite anion source with any raw materials containing unsaturated fatty acids that oxidize to form aldehydes or ketones before adding the raw materials to said food product.

Another embodiment of this aspect of the invention adds an antioxidant to the feed or food product so that after the feed or food product has been restored to a usable state and palatability has been improved it is stabilized against further oxidation. Methods according to this embodiment include the step of adding an effective amount of a feed- or food-grade anti-oxidant to the feed or food product. Examples of feed- and food-grade antioxidants include ethoxyquin, butylated hydroxyanisole (BHA), butylated hydroxytoluene (BHT), tertiary-butylhydroquinone, tocopherols, propyl gallate and rosemary extracts.

While any metabisulfite salt can be used as the metabisulfite species, including ammonium metabisulfite, alkali metal bisulfites are preferred, with sodium or potassium metabisulfite more preferred, and sodium metabisulfite most preferred. Upon contact with water, the metabisulfite species immediately forms aqueous bisulfite anions, which instantaneously react with any aldehydes and ketones that are present. The aldehydes and ketones form water-soluble organosulfites that are non-volatile and dissolve in water. Therefore, in another embodiment of this aspect of the invention, a method is provided in which the contacting step contacts the feed or food product with an aqueous solution of hydrated bisulfite so that any aldehydes or ketones present form water-soluble organosulfite salts that dissolve in the aqueous solution, and the method further includes the step of separating the feed or food product from the aqueous solution.

According to this embodiment, the contacting step can be performed once, or as often as necessary, to restore the feed or food product to a usable state and improve palatability. After the feed or food product is separated from the aqueous solution it can be dried for subsequent use, or it can be washed once or repeatedly with water prior to drying to remove any residual organosulfites and bisulfites.

Another embodiment of this aspect of the invention removes the organobisulfites from the aqueous solution in a way that regenerates bisulfite so that the aqueous bisulfite solution can be reused. Methods according to this embodiment include the steps of acidifying the aqueous solution after the step of separating the feed or food product therefrom, so that the organosulfite salt is converted back to the aldehyde or ketone and the bisulfite, and then separating the aldehyde or ketone from the aqueous bisulfite solution. After separating the aldehyde or ketone, preferred methods then contact the bisulfite solution with the same or different quantity of feed or food product.

The method of the present invention can thus be used to improve overly oxidized meats and meat by-products and animal fats and oils and vegetable oils to a usable state with improved palatability for use as raw materials in livestock feeds and companion animal food products. Because the inventive method contemplates methods in which antioxidants are added to stabilize the feed or food product, another aspect of the present invention provides a kit in which there is separate first and second containers, with a metabisulfite salt or aqueous solution thereof in the first container and one or more feed- or food-grade anti-oxidants in the second container.

Companion animal food manufacturers often blame palatability problems on the use of an ineffective palatability enhancer when they are using raw materials in which fatty acids have oxidized to form negative palatants that mask the palatability enhancer. Therefore, the method of the present invention is ideally used to remove oxidized fatty acids from livestock feeds and companion animal food products before the feed and food products are formulated with a palatability enhancer. Accordingly, one embodiment of the kit aspect of the invention is a kit with a third container of a companion animal food product palatability enhancing composition. Suitable palatability enhancing compositions contain one or more phosphate, pyrophosphate or polyphosphate salts.

The inventive method provides livestock feeds and companion animal food products containing organosulfites with no negative impact upon palatability derived from objection-able aldehyde and ketone oxidation products of unsaturated fatty acids. Therefore, according to another aspect of the present invention, an extruded livestock feed or companion animal food composition is provided that is prepared by contacting a basal composition containing unsaturated fatty acids that oxidize to form aldehydes or ketones with a source of bisulfite anions.

The basal composition may be mixed prior to extrusion with the source of bisulfite anions. In the alternative, the basal composition may be coated after extrusion with the source of bisulfite anions, preferably an aqueous solution of hydrated bisulfate, either before or after the application of a palatability enhancing composition. Aqueous palatability enhancing compositions can also be used that include bisulfite anion sources. Accordingly, the present invention also provides aqueous palatability enhancing compositions containing bisulfite anion sources. In another embodiment of this aspect of the invention, the basal composition or palatability enhancing composition contains a feed- or food-grade antioxidant.

Other features of the present invention will be pointed out in the following description and claims, which disclose the principles of the present invention, and the best modes which are presently contemplated for carrying them out.

### BRIEF DESCRIPTION OF THE DRAWINGS

FIG. 1 depicts the effect of bisulfite concentration on peroxide value for four commercially available basal companion animal food products; and

FIG. 2 is an image of a bisulfite adduct of hexanal.

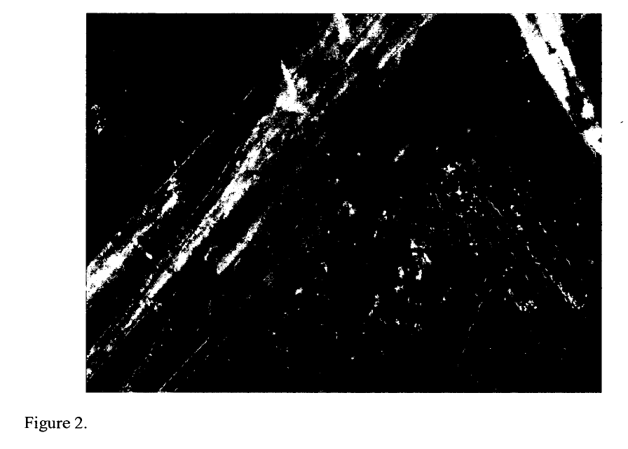

### DETAILED DESCRIPTION OF PREFERRED EMBODIMENTS

Methods according to the present invention contact overly oxidized livestock feed and companion animal food products with a source of bisulfite anions. Such feed and food products contain unsaturated fatty acids that have oxidized to form aldehydes and ketones having a negative impact on palatability, such as pentanal, hexanal and heptanal, especially hexanal. The present invention is based on the recognition that bisulfite has utility as a lipid oxidation chain breaker, leading to the discovery that it can be used in the present invention to attack peroxide and replace it with a sulfonate, thus causing peroxide levels to decrease. It was further recognized that bisulfite breaks the disulfide bond of cysteine and relaxes proteins, leading to the discovery that it can be used in the present invention against key enzymes, result in denaturation and enzyme inactivation.

The feed and food products are contacted with the source of bisulfite anions so that the aldehydes and ketones form organosulfite salts with no negative impact upon palatability. For purposes of the present invention, contact with bisulfite anion source occurs either by contact of a moist or dry feed or food product with an aqueous solution of hydrated bisulfite, or by contact of dry metabisulfite with a feed or food product with sufficient moisture to dissolve the metabisulfite and form bisulfite anions.

Livestock feed and companion animal food products are typically formed as a dry or semi-dry extruded kibble. For purposes of the present invention, any bite-sized piece of a dry or semi-dry livestock feed or companion animal pet food is referred to as a kibble, including those that may also be referred to as a pellet or by any other descriptive term. The contacting step can be performed by adding dry metabisulfite to a basal composition exposed to sufficient moisture during blending or steam conditioning to form bisulfite anions prior to extrusion, or an aqueous solution of hydrated bisulfite may be added to the extruder or sprayed on the surface of the kibbles after extrusion to soak therein and convert any aldehydes or ketones present to organosulfites. However any configuration allowing for the thorough admixture of feed or food product with bisulfite anions and water is suitable for use with the present invention, including the addition of aqueous bisulfite solutions during blending or steam conditioning. However, bisulfite solutions are preferably not added to moisture containing products because of the cost required to drive away excess water.

The inventive method can also be applied to moist companion animal food products such as moist dog or cat foods, which are cooked products. While the bisulfite anion source can be added before or after cooking, to do so after cooking is impractical because moist products are cooked by retorting sealed cans, which would then need to be opened for addition of the bisulfite anion source and resealed. Accordingly, for all practical purposes, the addition of the bisulfite anion source will occur prior to cooking.

Preferably, the raw material component containing an unsaturated fatty acid that oxidizes to form an aldehyde or ketone is contacted with the bisulfite anion source before the raw material is added to the food product. Raw materials containing such unsaturated fatty acids include raw meat and meat by-products and animal fats and oils and vegetable oils.

Of the dry metabisulfites added to products with sufficient moisture, alkali metal metabisulfites are preferred, with sodium or potassium metabisulfite being more preferred. Aqueous bisulfite solutions suitable for use with the present invention contain between about 0.0001 and about 20 wt % hydrated bisulfite, with a concentration between about 1 and about 9 wt % being preferred. The use of fresh solutions is also preferred.

The feed and food products are contacted with an amount of the bisulfite anion source that, depending upon the extent of oxidation, will improve palatability. This can be readily determined by one of ordinary skill in the art without undue experimentation, typically with reference to the peroxide value of the feed or food product. The amount is preferably a quantity that will restore the food or feed product to a usable state. For purposes of the present invention, “usable state” is defined as product that passes in commerce without customer objection, which refers to the satisfaction of purchasers with respect to consumption of product by their livestock or companion animals.

If too little is used, the contacting step can be repeated until a non-objectionable product is obtained. The feed or food product is contacted with a source of bisulfite anions effective to provide between slightly less and slightly more than a stoichiometric equivalent of bisulfite. Slightly less than a stoichiometric equivalent will still produce an unobjection-able product. However, residual bisulfite also has a negative impact upon palatability. There-fore, any stoichiometric excess should not provide a level of excess producing a negative impact upon palatability. This can also be readily determined by one of ordinary skill in the art without undue experimentation, typically with reference to residual analysis of bisulfite.

Accordingly, preferred feed and food products are prepared by contact with a quan-tity of dry metabisulfite or aqueous bisulfite solution that adds to the products an amount of bisulfite anions effective to convert at least 90% by weight of volatile ketones and aldehydes to organosulfites. Typically, between about 0.01 and about 1.25% by weight of bisulfite is added to the feed or food product, most or all of which is then converted to organosulfite. Preferably, between about 0.1 and about 0.9% by weight of bisulfite is added to the products with a quantity between about 0.6 and about 0.8% by weight being most preferred.

As referred to within this description, dry and semi-dry companion animal foods generally relate to a nutritionally balanced mixture of proteinaceous and farinaceous materials having moisture contents of about 50% or less by weight. Moist companion animal food products generally relate to a nutritionally balanced mixture of proteinaceous and farinaceous materials having moisture contents above 50% by weight.

In moist food products, the proteinaceous and farinaceous materials are typically formed into a solid mass with a hydrocolloid such as gelatin. The meat in moist food products can be supplied by chunks of actual meet or by re-formed emulsified meat and meat by-products. Moist companion animal food may also optionally include a gravy component prepared from hydrocolloids and flavorings, and for this reason bisulfites are preferably added to the meat component.

The companion animal food compositions described herein are not intended to be limited to a specific listing of ingredients because such ingredients will depend on such factors as, for example, the desired nutritional balance for the specific type of companion animal, and availability of ingredients to the manufacturer. In addition to the proteinaceous and farinaceous materials, the companion animal food composition may include vitamins, minerals, and other additives such as flavorings, preservatives, emulsifiers and humectants. The nutritional balance, including the relative proportions of vitamins, minerals, fat, protein and carbohydrate, is determined according to dietary standards known in the veterinary art. For example, the nutritional balance of a cat food composition is determined according to the known dietary requirements for cats.

Livestock feeds relate to grain and silage compositions and like companion animal food products also include vitamins, minerals, and other additives such as flavorings, preservatives, emulsifiers and humectants. The nutritional balance, including the relative proportions of vitamins, minerals, fat, protein and carbohydrate, is determined according to dietary standards known in the large animal veterinary art.

Suitable proteinaceous material may include any material having a protein content of at least about 15% by weight including vegetable proteins such as soybean, cotton seed, and peanut; animal proteins such as casein, albumin, and fresh animal tissue including fresh meat tissue and fresh fish tissue; and dried or rendered meals such as fish meal, poultry meal, meat meal, bone meal and the like. Other types of suitable proteinaceous materials include wheat gluten or corn gluten, and microbial proteins such as yeast.

Suitable farinaceous material may comprise any material having a protein content of less than about 15% by weight and containing a substantial proportion of starches or carbohydrates, including grains such as corn, milo, alfalfa, wheat, barley, rice, soy hulls, and other grains having low protein content. In addition to the proteinaceous and farinaceous materials, other materials such as whey and other dairy by-products, as well as other carbohydrates may be added. In addition, known flavorings including, for example, corn syrup or molasses, may be added.

Generally, the terms livestock feed composition and companion animal food composition as used herein apply to commercially sold, nutritionally balanced compositions that are intended to provide substantially the sole diet for livestock and companion animals. Thus, such compositions may be described as having minimum protein contents at which livestock and companion animal health is maintained. However, the minimum protein content of the food varies according to the age and breeding status for the animal.

For example, a nutritionally balanced cat food composition for breeding females and kittens requires a minimum protein content of at least about 28% by weight on a dry matter basis. A nutritionally balanced cat food composition for non-breeding and adult cats requires a minimum protein content of about 26% by weight on a dry matter basis. More typically, the protein content of commercially available cat food compositions for adult, non-breeding cats is about 30% by weight on a dry matter basis, to insure that the food meets the nutritional requirements of any cat.

For example, a typical formula well known in the art for a dry companion animal food composition to which the source or bisulfite anions is applied is as follows:

0%-70% by weight grain-based meal or flour, such as corn, wheat, barley or rice;

0%-30% by weight animal by-product meal, such as poultry or beef meal;

0%-25% by weight corn gluten meal;

0%-25% by weight fresh animal tissue, such as poultry or beef tissue;

0%-25% by weight soybean meal or flour;

0%-25% by weight fresh fish tissue;

0%-20% by weight seafood-based meal;

0%-10% by weight animal fat;

0%-10% by weight high fructose corn syrup;

0%-10% by weight dried molasses;

0%-1.5% by weight phosphoric acid; and

0%-1.5% by weight citric acid.

Additionally, vitamins and minerals are added according to known American Association of Feed Control Officials (AAFCO) guidelines. Such AAFCO profiles include calcium carbonate, potassium chloride, sodium chloride, choline chloride, taurine, zinc oxide, ferrous sulfate, vitamin E, vitamin A, vitamin B12, vitamin D3, riboflavin, niacin, calcium pantothenate, biotin, thiamine mononitrate, copper sulfate, folic acid, and pyroxidine.

Livestock feeds are typically prepared from vegetable materials edible by ruminants, such as legume hay, grass hay, corn silage, grass silage, legume silage, corn grain, barley, oats, distiller's grain, brewer's grain, soya bean meal and cottonseed meal. A typical formula well known in the art for a dry livestock food composition to which the source of bisulfite anions is applied is as follows:

0%-70% by weight grain-based meal or flour, such as corn, wheat, barley or rice;

0%-30% by weight animal by-product meal, such as poultry or beef meal;

0%-25% by weight corn gluten meal;

0%-25% by weight soybean meal or flour;

0%-20% by weight seafood-based meal;

0%-10% by weight animal fat;

0%-10% by weight high fructose corn syrup;

0%-10% by weight dried molasses;

0%-1.5% by weight phosphoric acid; and

0%-1.5% by weight citric acid.

Dry and semi-dry livestock feed and companion animal foods may be prepared by a variety of methods. One such method that is widely used on commercial basis is the cooker-extruder method. In the cooker-extruder method, dry ingredients are first blended together to form an admixture. This admixture is transferred into a steam conditioner where it is sufficiently moistened to become extrudable. The admixture then enters a cooker/extruder where it is cooked at an elevated temperature and pressure for a short period of time and then forced out of the apparatus through a die. This die forms the extruded product into a specific shape.

Individual pieces of product are created by periodically slicing off the end of the extruded stream of product. The individual pieces, or kibbles, are then dried in a hot air dryer. Generally, the product is dried until it contains less than about 15 percent moisture, and preferably about 9 to 12 percent moisture. The resulting pebbles or kibbles constitute the basal feed or food composition.

With dry and semi-dry companion animal food compositions, the dried particles or pieces are then transferred by bulk conveyor to a coating drum and sprayed with animal fat. Other liquids such as, for example, citric acid or phosphoric acid may alternatively be applied to the pieces, or applied with or in addition to the animal fat, during or after which a coating of the palatability enhancer is typically applied.

The coating need not be a continuous layer, but preferably is uniform. After the fat cools, if not included with the fat coating, the palatability enhancer may be applied as either a dry power or a liquid, or both, while the product is mixing. A liquid palatability enhancer is typically sprayed on while a dry palatability enhancer is typically dusted on, preferably through a mesh screen to make the application more uniform on the particles or pieces. Alternatively, a palatability enhancer can be mixed with the fat and applied concurrently. Note that multiple coatings may be applied to achieve uniformity of the coating.

For extruded products, the source of bisulfite anions may be contacted with the livestock feed or companion animal food ingredients before extrusion by adding dry metabisulfite to the ingredients during blending or steam conditioning, or adding aqueous bisulfite solution to the cooker/extruder. Aqueous bisulfite solution may also be applied to the extruded particles or pieces. With companion animal food products, the aqueous solution is applied before the particle or piece is coated with animal fat, which would interfere with the ability of the bisulfite to contact any aldehydes or ketones.

Moist companion animal food products that are gravy based are prepared by grinding meat, meat mimetics or meat by-products and then forming the ground mixture via low pressure extrusion through a steaming tunnel where it is cooked. Starch and binders are then added, after which the mixture is cut into pieces, mixed with water or gravy, sealed in cans and cooked in a hydrostat, continuous retort or rotary steritort

Moist companion animal food products that are not gravy based are prepared by macerating meat, meat mimetics or meat by-products and re-forming the macerated materials with water, starch and binders. The mixture is then sealed in cans and cooked in a hydrostat, continuous retort or rotary steritort.

Semi-moist products are prepared by macerating and mixing meat, meat by-products or meat mimetics, precooking the mixture, and then mixing the product with humectants such as glycerol, polysorbate, tween, and spans to hold water. The resulting mixture can be formed and put into a can or pouch for retorting or press-formed and cooked or retorted in a pouch.

For purposes of the present invention meat and meat by-products are defined as including meat and meat by-products from animal species and fish species. Examples of animal meat and meat by-products for which palatability can be improved by the method of the present invention include, but are not limited meat and meat by-products derived from beef, pork, sheep or lamb, poultry, duck, and the like. Examples of fish products and fish by-products that can be used include, but are not limited to, products and by-products derived from tuna, salmon, cod, whitefish, shrimp, and the like.

Examples of unsaturated animal fats and oils and vegetable oils for which palatability can be improved by the present invention include animal fats such as tallow, chicken fat and lard and vegetable oils such as canola oil, sunflower oil, safflower oil, cotton seed oil, canola oil, linseed oil, soybean oil, olive oil, corn oil, and the like, and byproducts thereof. Examples of animal oils include marine oils and byproducts thereof, such as marine oils from sources such as menhaden, herring, mackerel, caplan, tilapia, tuna, sardine, Pacific saury, krill, salmon, anchovy, skate, whale, seal, crab, shrimp, lobster, eel, mollusk, and the like. Vege-table oils also include oils derived from marine vegetation such as algae, kelp and the like.

Preferred methods according to the present invention add one or more feed- or food-grade antioxidants to the feed or food products to slow the subsequent production of the offending aldehydes and ketones. Suitable antioxidants include, but are not limited to, ethoxyquin, BHA, BHT, tertiary-butyl hydroquinone, propyl gallate, tocopherols, rosemary extracts, and the like. Quantities between about 0.01 and about 1000 ppm should be used.

The present invention also includes methods in which the livestock feed or companion animal food product is washed with an aqueous bisulfite solution so that organosulfites formed from any aldehydes or ketones present dissolve in the aqueous solution, after which the feed or food product is separated from the aqueous solution. The recovered raw materials are optionally washed with water to remove residual organosulfites and bisulfites.

It may also be necessary to repeat this process step one or more times before a useable raw material is obtained, which is then dried before being formulated into a livestock animal feed or companion animal food product. This embodiment of the inventive method can also be used to improve the palatability of oxidized raw materials containing unsaturated fatty acids intended for use in essentially any livestock feed or pet food product for a companion animal, including dry, semi-dry and moist pet food products.

After the feed or food product has been removed from the aqueous solution, the aqueous solution may be acidified by conventional means to regenerate the aldehyde or ketone and bisulfite. The regenerated aldehyde or ketone may be separated from the aqueous solution by conventional solvent extraction techniques, such as by washing the aqueous solution with ether.

The regenerated bisulfite solution can then be reused, either to wash the same quantity of raw materials a second time, or to wash a new quantity of raw material. The regenerated solutions can be used in a series of batch processes, or the solution regeneration can be part of a continuous process in which regenerated bisulfite solution is continuously delivered to a constant supply of raw material. In a continuous process, water or bisulfite may be periodically replenished to maintain an essentially constant solution concentration.

The present invention contemplates the assembly of kits in which separate containers of a feed- or food-grade antioxidant and a metabisulfite species or aqueous bisulfite solution are distributed in combination. This promotes an objective of the invention to improve an overly oxidized product to a usable state and thereby improve palatability and then stabilize the resulting product through the addition of one or more antioxidants.

Preferred kits will have as a primary component in a separate container a palatability enhancing composition for companion animal food products. The purpose of a three-container kit is to distribute metabisulfite and antioxidants with a palatability enhancing composition to remove offending aldehydes and ketones from oxidized raw materials and stabilize the raw materials against further oxidation before the raw materials are formulated with palatability enhancing compositions.

Preferred palatability enhancing compositions contain one or more palatability enhancing compounds, examples of which include pyrophosphoric acid and the sodium, potassium, calcium and magnesium salts thereof, phosphoric acid and the sodium, potassium, calcium and magnesium salts thereof, sodium, potassium, calcium and magnesium tripolyphosphate salts, potassium, calcium and magnesium hexapolyphosphate salts, or organic acids such as citric, tartaric, fumaric, lactic, acetic, formic and hexamic acids and the sodium, potassium, calcium and magnesium salts thereof, and the like. Examples of suitable palat-ability enhancing compositions are disclosed in U.S. Pat. App. Publication No. 2005/0106285 published May 19, 2005, the disclosure of which is incorporated herein by reference.

The present invention also includes livestock feed and companion animal food products prepared according to the method of the present invention in which organosulfites are present resulting from the reaction of aldehydes and ketones with bisulfite. These organosulfites have no negative impact upon palatability. Extruded feed and food compositions are included that have been contacted with bisulfite both before and after extrusion. Preferred products include products containing one or more antioxidants and products coated with a palatability enhancing composition.

Moist companion animal food compositions are also included that have been contacted with a bisulfite anion source, preferably prior to cooking. Preferred products are contacted with a bisulfite anion source by contacting raw materials containing unsaturated fatty acids with the bisulfite anion source before such raw materials are added to the food product. Other preferred products include products containing one or more antioxidants and products containing a palatability enhancing composition.

The present invention also includes palatability enhancing compositions for companion animal food products containing a source of bisulfite anions, the application of which both converts any volatile ketones and aldehydes present to non-volatile organosulfites and supplies a palatability enhancing component. An improved enhancement of palatability is obtained because negative palatants are eliminated that would otherwise detract from the effect of the palatability enhancer.

The palatability enhancers of the present invention contain from about 0.1% to 80% by weight of one or more palatability enhancing compounds, examples of which are listed above. Palatability enhancing compound levels between about 5 and about 50% by weight are preferred, with levels between about 10 and about 35% by weight more preferred, and levels between about 15 and about 30% by weight even more preferred.

The palatability enhancers are formulated and applied so that the one or more palatability enhancing compounds constitute from about 0.01% to about 5.0% by weight of the finished pet food product. Preferably, the palatability enhancers are formulated so that the one or more palatability enhancing compounds constitute from about 0.05 to about 2.0% by weight of the finished pet food product, more preferably between about 0.1 to about 1.0% by weight, and even more preferably between about 0.25 and about 0.75 wt %.

The preferred palatability enhancers according to the present invention contain from about 0.01% to about 20% by weight of a source of bisulfite anions, with levels between about 1% and about 9% by weight preferred. Preferably, the palatability enhancers are formulated with a quantity of dry metabisulfite or aqueous bisulfite solution that adds between about 0.01 and about 1.25% by weight of bisulfite to the food product, most or all of which is then converted to organosulfite. Preferably, between about 0.01 and about 0.2% by weight of bisulfite is added to the food product with a quantity between about 0.025 and about 0.15% by weight being most preferred.

Preferred palatability enhancers according to the present invention further contain one or more feed or food grade anti-oxidants, examples of which are listed above, at a level effective to supply the food product with a level of anti-oxidant sufficient to stabilize the product against further aldehyde and ketone formation. A level between about 0.01% and 2.5% by weight in the palatability enhancing composition should be used, with a level between about 0.1% and about 1.0% by weight preferred. Preferably, the palatability enhancers are formulated with a quantity of anti-oxidant that adds between about 0.01 and about 1000 ppm of anti-oxidant to the food product

Among the preferred palatability enhancers according to the present invention are palatability enhancers containing from about 5 to about 99 wt. % of one or more products or by-products selected from the above described meat products, meat by-products, meat mimetics, dairy products and dairy by-products. Examples of dairy products and dairy by-products that can be used include, but are not limited to, products and by-products derived from cheese, milk protein, whey, and the like.

Preferred products and by-products that may be present alone or in combination include products and by-products of beef and poultry. Fish products and by-products are also preferred. A product or by-product level between about 20 and about 70 wt. % is preferred.

Among the same or other preferred palatability enhancers according to the present invention are palatability enhancers containing from about 0.01 to about 10 wt. % of one or more amino acids. Examples of amino acids that can be used include, but are not limited to, alanine, glycine, cysteine, and the like. Preferred amino acids that may be present alone or in combination include glycine, L-alanine, and the like. An amino acid level between about 0.1 and about 4.0 wt. % is preferred.

Among the same or other preferred palatability enhancers according to the present invention are palatability enhancers containing from about 5 to about 70 wt. % of one or more microbial or vegetable proteins. Examples of microbial proteins that can be used include, but are not limited to, brewer's yeast, baker's yeast, and the like. Examples of vegetable proteins that can be used include, but are not limited to, corn gluten, soy protein, soy flour, hydrolyzed vegetable protein (HVP), and the like. Microbial or vegetable protein levels from about 10 to about 40 wt. % are preferred.

Among the same or other preferred palatability enhancers according to the present invention are palatability enhancers containing from about 0.01 to about 50 wt. % of one or more carbohydrates. Examples of carbohydrates that can be used include, but are not limited to, glucose, xylose, fructose, starch hydrolysates, and the like. A carbohydrate level between about 10 and about 30 wt. % is preferred.

One example of a preferred formulation has a solids content of from about 10 to about 40 wt. % of one or more palatability enhancing compounds; about 30 to about 60 wt. % of one or more products or by-products selected from animal products, animal by-products, fish products, fish by-products, dairy products and dairy by-products; from about 25 to about 35 wt. % of one or more sources of microbial proteins; from about 1 to about 9 wt. % by weight bisulfite; from about 0.1 to about 1.0 wt. % of one or more anti-oxidants; from about 2 to about 4 wt. % of one or more amino acids; and from about 0.5 to about 60 wt % of one or more carbohydrates.

Dry formulations have a solids content of about 96 wt %. Liquid formulations may be diluted to a total solids content as low as about 30 wt % with water and preferably to a solids content no more than about 50 wt % to obtain a viscosity and rheology suitable for spray application.

The water content may also be supplied by moisture-containing or liquid components such as aqueous bisulfite solutions, the amounts of which are selected by well-known techniques to maintain the solids content of the product. Liquid formulations according to the present invention have a pH between about 2 and about 9. Preferred liquid formulations have a pH between about 2 and about 3.

To make a liquid palatability enhancer formulation according to the present invention, for example, commercially available liquid ingredients are combined in a mixer. Wet ingredients are ground or emulsified to a slurry and the liquid ingredients are combined therewith. A commercially available protease may be added to the slurry to hydrolyze proteins, and later inactivated with heat, acid or another method. Preservatives such as sorbic acid can also be added. Water is added to adjust the viscosity and the solids content of the slurry to facilitate spray application. The wet palatability enhancer is sprayed onto the product so as to achieve a uniform coating and permitted to dry.

A dry formulation of the palatability enhancer is prepared according to one embodiment of the present invention, by combining commercially available dry ingredients, including the palatability enhancing compound, dry metabisulfite, amino acids, inorganic salts and organic materials in the desired proportions in a batch mixer and blending to homogeneity prior to drying.

According to another dry formulation embodiment, wet and dry ingredients are combined by mixing the wet ingredients with all or some of the dry ingredients in a mixer until a homogenous mixture is formed. The mixture is dried by evaporation or lyophilization, for example, to form a dry, powdery product that is then blended with any remaining dry ingredients in a tumbler until a homogeneous mixture is formed.

The inventive method can also be applied to recondition used fryer oils and other oil and fat products that have been oxidized or heat stressed. The oil or liquid fat is first contacted with a strong base such as NaOH or KOH to convert free fatty acids to soaps and eliminate them from the oil. The resulting liquid is then contacted with a metabisulfite species to remove aldehydes and ketones. In preferred methods the base and metabisulfite species are sequestered on inert supports over which the oil or liquid fat is sequentially passed.

The following non-limiting examples set forth below illustrate certain aspects of the invention. These examples are not intended to limit the scope, but rather to exemplify preferred embodiments. All parts and percentages are by weight unless otherwise noted and all temperatures are in degrees Celsius.

### EXAMPLES

### Examples 1-9

### Treatment of Chicken Meal with Aqueous NaHSO₃ Solution

Highly oxidized unadulterated chicken meal with 4.83 wt % moisture content was purchased from a major feed supplier. Their most-oxidized inventory was specifically requested. The extent of oxidation was confirmed by odor sampling, peroxide value, and hexanal analyses. Samples were treated at ambient temperature (25° C.) at a rate of 50 mL bisulfite solution per 200 g of chicken meal sample in brown glass sample bottles with bakelite lids. Bisulfite concentration varied from 0 to 9% wt/vol. The 50 mL water sample without bisulfite was used as the control to eliminate the impact of moisture variation on palatability. Brown glass was used to eliminate UV light as a potential source of bleaching effects.

The samples were rotated on a roller table with collections at 0, 5, 15, 30 and 60 minutes. Collected samples were immediately frozen and held for analysis. Analysis consisted of subjecting the bottle head space for GC and MS identification and quantification. Results for treatment with 3%, 4% and 6% bisulfite versus the control are shown in Table 1:

TABLE 1
Effect of different NaHSO₃ treatments on level of oxidative aldehydes in chicken meal

| | Treatment Time | | | | | | | | | | | |
|---|---|---|---|---|---|---|---|---|---|---|---|---|
| | 0 (min) | | | | 15 (min) | | | | 60 (min) | | | |
| | Example | | | | | | | | | | | |
| | Control | 1 | 2 | 3 | Control | 4 | 5 | 6 | Control | 7 | 8 | 9 |
| % Bisulfite | 0% | 3% | 4% | 6% | 0% | 3% | 4% | 6% | 0% | 3% | 4% | 6% |
| Components: | Ratio to I.S.¹ | | | | Ratio to I.S. | | | | Ratio to I.S. | | | |
| Hexanal | 36.607 | 4.826 | 3.05 | 1.833 | 34.228 | 15.187 | 4.241 | 2.17 | 36.855 | 10.045 | 9.212 | 3.339 |
| | | (−86.8)² | (−91.7) | (−95.0) | | (−55.6) | (−87.6) | (−93.2) | | (−72.7) | (−75.0) | (−90.9) |
| Butanal | .455 | —³ | — | — | 0.412 | 0.064 | — | — | 0.440 | 0.038 | 0.031 | — |
| Pentanal | 5.232 | 0.293 | 0.154 | 0.085 | 4.898 | 1.116 | 0.248 | 0.116 | 5.273 | 0.737 | 0.635 | 0.190 |
| Heptanal | 1.076 | 0.269 | 0.174 | 0.099 | 1.016 | 0.853 | 0.243 | 0.115 | 1.101 | 0.596 | 0.563 | 0.182 |
| 2-Heptanal | 0.049 | — | — | — | — | — | — | — | 0.050 | — | — | — |
| Octanal | 0.359 | 0.144 | 0.106 | 0.065 | 0.326 | 0.397 | 0.132 | 0.068 | 0.361 | 0.304 | 0.267 | 0.098 |
| Nonanal | 0.291 | 0.241 | 0.217 | 0.160 | 0.320 | 0.491 | 0.224 | 0.129 | 0.378 | 0.457 | 0.399 | 0.169 |

¹I.S. = Internal Standard (6-Methyl-5-hepten-2-one)
²( ) percent aldehyde reduction
³— indicates nondectectable

The average reduction of hexanal in the 3%, 4% and 6% samples were 71.7%, 84.8% and 93.0%, respectively.

### Examples 10-12

### Treatment of Kibble with Aqueous NaHSO₃ Solution

An aged commercially-available kibble was purchased. The kibble was typical from a nutritional perspective but highly oxidized. The kibble was predominantly grain-based but also contained pork and chicken by-products and a variety of animal and vegetable fats. Peroxide values were measured to confirm that the samples were oxidatively challenged.

The kibble was treated as in Examples 1-9, except that 100 g of kibble was treated with 10 mL of bisulfite solution at concentrations from 0 to 9% wt/vol. Results for treatment with bisulfite versus the control are shown in Table 2:

TABLE 2
Comparison of oxidative aldehydes of
kibble different NaHSO₃ treatments

Example

| | Control | 10 | 11 | 12 |
|---|---|---|---|---|
| % Bisulfite Solution | 0% | 5% | 7% | 9% |
| Addition Rate | 10 ml/100 g kibble | | | |
| Components | Ratio to I.S.¹ | | | |
| Hexanal | 3.744 | 1.852 | 0.81 | 0.558 |
| | | (−50.5)² | (−78.4) | (−85.1) |
| Butanal | —³ | — | — | — |
| Pentanal | 0.592 | 0.268 | 0.084 | 0.07 |
| Heptanal | 0.188 | 0.062 | 0.052 | — |
| 2-Heptenal | — | — | — | — |
| Octanal | 0.124 | — | 0.04 | — |
| Nonanal | 0.068 | 0.042 | 0.024 | — |

¹I.S. = Internal Standard (6-Methyl-5-hepten-2-one)
²( ) percent aldehyde reduction
³— indicates nondectectable

All three concentrations demonstrated significant reductions in hexanal levels.

### Examples 13-16

### Measurement of Peroxide Values

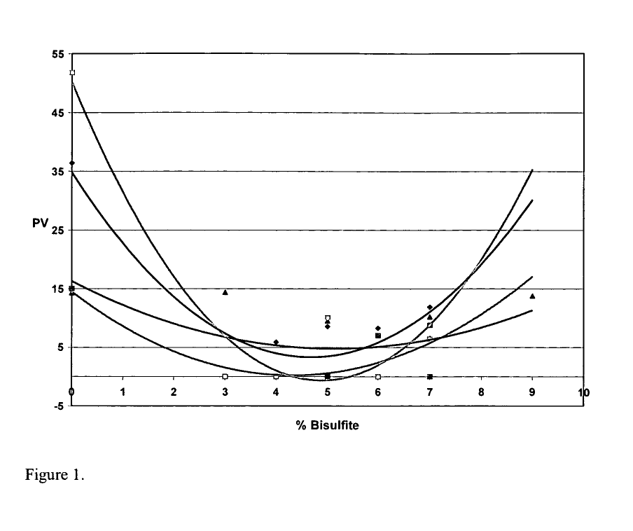

Four commercially available kibble brands were purchased and treated as in Examples 10-12 with bisulfite concentrations between 3 and 9% wt/vol. Peroxide values were measured, with the results shown in FIG. 1, which depicts an optimum concentration range for bisulfite treatment.

### Examples 17-20

### Dog Palatability Testing of Treated Oxidized Kibble

Palatability of treated kibble was measured using standard two bowl methodology. The treated kibble of Examples 10-12 was evaluated against a water-treated control. Test panels consisted of a minimum of 20 animals. Test duration was one or two days, with measurement of consumption ratio (CR) and first choice (FC). Results were analyzed by two-tail Student-T test and are depicted in Table 3.

TABLE 3
Effect of different NaHSO₃ treatments to oxidized dog kibble on palatability

| | Panel/ | Variable | Variable | Average- | Average- | Day-1 | Day-1 | Day-2 | Day-2 |
|---|---|---|---|---|---|---|---|---|---|
| Example | #dogs | A¹ | B² | CR | FC | CR | FC | CR | FC |
| 17 | 6/21 | Control¹ | +3% bisulfite | 1:1.2 | 1:1.11 | 1:1.34 | 2.33:1 | 1:1.08 | 1:3 |
| 18 | 3/22 | Control | +4% bisulfite | 1:1.35 | 1:2.35 | 1:1.57 | 1:4 | 1:1.16 | 1:1.38 |
| 19 | 4/21 | Control | +6% bisulfite | 1:2.53 | 1:4.67 | 1:2.13 | 1:8 | 1:3.04 | 1:3 |
| 20 | 7/21 | Control | +7% bisulfite | 1:2.49 | 1:1.62 | 1:2.32 | 1:1.13 | 1:2.68 | 1:2.4 |

¹Variable-A: Control Base + water (10 ml/100 g kibble)
²Variable-B: Control Base + bisulfite solution (10 ml/100 g kibble)

The dogs exhibited a significant preference for bisulfite-treated kibble, with the preference increasing as the bisulfite concentration increased.

### Examples 21-23

### Dog Palatability Testing of Treated Kibble Made from Fresh Ingredients

As a comparison, Example 18 palatability testing was repeated on dogs with kibble prepared in-house from fresh ingredients. Kibbles treated with between 3 and 7% wt/vol bisulfite were evaluated against water-treated control. The results are shown in Table 4:

TABLE 4
Effect of different NaHSO₃ treatments to fresh dog kibble on palatability

| | Panel/ | Variable | Variable | Average- | Average- | Day-1 | Day-1 | Day-2 | Day-2 |
|---|---|---|---|---|---|---|---|---|---|
| Example | #dogs | A¹ | B² | CR | FC | CR | FC | CR | FC |
| 21 | 1/22 | Control¹ | +3% bisulfite | 2.45:1 | 2.14:1 | 2.58:1 | 1.75:1 | 2.34:1 | 2.67:1 |
| 22 | 2/22 | Control | +4% bisulfite | 1.66:1 | 1.06:1 | 1.78:1 | 2.6:1 | 1.55:1 | 1:2.4 |
| 23 | 3/22 | Control | +7% bisulfite | 1.19:1 | 1:1 | 1.03:1 | 1.5:1 | 1.38:1 | 1:1.5 |

¹Variable-A: Control Base + water (10 ml/100 g kibble)
²Variable-B: Control Base + bisulfite solution (10 ml/100 g kibble)

Because there were no inherent palatability issues with the kibble, the dogs did not express a preference for the bisulfite-treated materials.

### Examples 24-28

### Dog Palatability Testing of Treated Oxidized Chicken Meal

Fresh dog kibble, similar to that in Examples 21-23, was coated with aged chicken meal, either treated with bisulfite (as in Examples 1-9) or untreated. Palatability of kibble with untreated aged chicken meal was measured against that of treated aged chicken meal. The palatability of the coated samples was evaluated with dogs using the standard two-bowl methodology of Examples 17-20. The results are shown in Table 5:

TABLE 5
Effect of NaHSO₃-treated aged chicken meal on palatability as coated on fresh dog kibble

| | Panel/ | Variable | Variable | Average- | Average- | Day-1 | Day-1 | Day-2 | Day-2 |
|---|---|---|---|---|---|---|---|---|---|
| Example | #dogs | A¹ | B² | CR | FC | CR | FC | CR | FC |
| 24 | 7/21 | 1% untreated | 1% meal/ | 1:1.3 | 1:2 | 1:1.17 | 1:2.4 | 1:1.45 | 1:1.71 |
| | | meal | w/6% bisulfite | | | | | | |
| 25 | 6/21 | 2% untreated | 2% meal/ | 1:1.16 | 1:2 | 1:1.25 | 1:2.33 | 1:1.08 | 1:1.71 |
| | | meal | w/3% bisulfite | | | | | | |
| 26 | 7/21 | 2% untreated | 2% meal/ | 1:1 | 1:1.11 | 1.02:1 | 1:1.71 | 1:1.02 | 1.38:1 |
| | | meal | w/5% bisulfite | | | | | | |
| 27 | 6/21 | 2% untreated | 2% meal/ | 1:2.24 | 1:1.8 | 1:1.89 | 1:1.33 | 1:2.68 | 1:2.5 |
| | | meal | w/7% bisulfite | | | | | | |
| 28 | 7/21 | 2% untreated | 2% meal/ | 1.05:1 | 1.05:1 | 1.26:1 | 1:1 | 1:1.14 | 1.11:1 |
| | | meal | w/9% bisulfite | | | | | | |

¹Variable-A: Fresh Dog Base + 5% TPF + untreated aged chicken meal
²Variable-B: Fresh Dog Base + 5% TPF + bisulfite-treated aged chicken meal

Dogs exhibited a preference for kibble coated with aged chicken meal treated with bisulfite solutions over kibble coated with aged chicken meal, which was untreated.

### Examples 29-34

### Dog Palatability Testing of Chicken Meal without the Addition of Antioxidants

Prior to extrusion, a commercially available base formula was modified to include chicken meal without the addition of antioxidants. The modified base formula was then extruded with dry or liquid addition of sodium metabisulfite to form kibble for the palatability testing. All samples showed a positive effect of bisulfite on palatability compared with the control sample to which no bisulfite was added. The results are depicted in Table 6:

TABLE 6
Effect of internal addition of bisulfite on palatability
as added to inferior dog kibble during extrusion

| | Variable | Variable | Average | Average | |
|---|---|---|---|---|---|
| Example | A | B | CR | FC | PV-B |
| 29 | Control | +0.3% Dry | 1:5.42 | 1:3.00 | 8.42 |
| 30 | Control | +0.5% Dry | 1:3.91 | 1:3.88 | 3.85 |
| 31 | Control | +0.7% Dry | 1:4.32 | 1:7.00 | 6.44 |
| 32 | Control | +0.3% Liquid | 1:3.60 | 1:3.88 | 7.77 |
| 33 | Control | +0.5% Liquid | 1:2.04 | 1:3.67 | 5.43 |
| 34 | Control | +0.7% Liquid | 1:2.36 | 1:5.33 | 7.93 |
| | | | | | PV-A |
| | | | | | 10.8 |

### Examples 35-38

### Cat Palatability Testing of Treated Oxidized Kibble

An aged and highly oxidized commercially available cat kibble was purchased and treated as in Examples 10-12. The treated kibble was evaluated with cats against a water-treated control as in Examples 17-20. Similar to the dog trials, palatability was measured using a standard two bowl methodology. The results are depicted in Table 7:

TABLE 7
Effect of different NaHSO₃ treatments to oxidized cat kibble on palatability

| | Panel/ | Variable | Variable | Average- | Average- | Day-1 | Day-1 | Day-2 | Day-2 |
|---|---|---|---|---|---|---|---|---|---|
| Example | #dogs | A¹ | B² | CR | FC | CR | FC | CR | FC |
| 35 | 4/22 | Control¹ | +1% bisulfite | 1:1.49 | 1:2.3 | 1:2.12 | 1:5.67 | 1:1.08 | 1.17:1 |
| 36 | 4/22 | Control | +3% bisulfite | 1.03:1 | 1:1.25 | 1:1.16 | 1:1.16 | 1.24:1 | 1:1.25 |
| 37 | 5/24 | Control | +5% bisulfite | 1:3.19 | 1:3.57 | 1:2.58 | 1:5.67 | 1:4.05 | 1:2 |
| 38 | 6/22 | Control | +7% bisulfite | 1:1.90 | 1:3 | 1:2.23 | 1:4.33 | 1:1.53 | 1:1.5 |

¹Variable-A: Control Cat Base + water (10 ml/100 g kibble)
²Variable-B: Control Cat Base + bisulfite solution (10 ml/100 g kibble)

The cats exhibited a significant preference for bisulfite-treated kibble. These Examples were repeated with addition of a palatability enhancing composition to both the bisulfite-treated kibble and water-treated controls. A preference was again shown for the treated samples.

### Examples 39-42

### Cat Palatability Testing of Treated Oxidized Chicken Meal

Examples 39-42 were repeated by coating a cat kibble prepared freshly in-house with untreated and bisulfite-treated chicken meal. The palatability of the coated samples was evaluated as in Examples 24-28, but with cats using the standard two-bowl methodology of Examples 17-20. The results are shown in Table 8:

TABLE 8
Effect of NaHSO₃-treated aged chicken meal on palatability as coated on fresh cat kibble

| | Panel/ | Variable | Variable | Average- | Average- | Day-1 | Day-1 | Day-2 | Day-2 |
|---|---|---|---|---|---|---|---|---|---|
| Example | #dogs | A¹ | B² | CR | FC | CR | FC | CR | FC |
| 39 | 3/22 | 2% untreated | 2% meal/ | 1:1.56 | 1:1.27 | 1:2.15 | 1:1.63 | 1:1.15 | 1.17:1 |
| | | meal | w/3% bisulfite | | | | | | |
| 40 | 4/22 | 2% untreated | 2% meal/ | 1:1.34 | 1.55:1 | 1:1.37 | 1:1 | 1:1.3 | 1:1 |
| | | meal | w/5% bisulfite | | | | | | |
| 41 | 5/24 | 2% untreated | 2% meal/ | 1:2.45 | 1:2.25 | 1:2.3 | 1:3.33 | 1:2.62 | 1:1.6 |
| | | meal | w/7% bisulfite | | | | | | |
| 42 | 6/22 | 2% untreated | 2% meal/ | 1:2.37 | 1:1.18 | 1:2.74 | 1.25:1 | 1:2.06 | 1:1.5 |
| | | meal | w/9% bisulfite | | | | | | |

¹Variable-A: Fresh Cat Base + 5% TPF + untreated aged chicken meal
²Variable-B: Fresh Cat Base + 5% TPF + bisulfite-treated aged chicken meal

Cats exhibited a preference for kibble coated with a palatability enhancing composition and bisulfite-treated chicken meal over kibble coated with untreated chicken meal and a palatability enhancing composition.

Commercial moist cat food formulations were treated with bisulfite concentrations of 9% wt/vol and 15% wt/vol and evaluated with cats as in Examples 39-42. A preference for the treated compositions was again expressed.

### Examples 43-47

### Cat Palatability Testing of Chicken Meal without the Addition of Antioxidants

Prior to extrusion, a commercially available base formula was modified to include chicken meal without the addition of antioxidants. The modified base formula was then extruded with dry addition of sodium metabisulfite to form kibble for the palatability testing, similar to Examples 29-31. The results depicted in Table 9 show a positive effect of bisulfite on palatability compared with the control sample to which no bisulfite was added.

TABLE 9
Effect of internal addition of bisulfite on palatability as added to inferior cat kibble during extrusion

| | Days/ | Variable | | Average- | Average- | Day-1 | Day-1 | Day-2 | Day-2 |
|---|---|---|---|---|---|---|---|---|---|
| Example | Cats | A¹ | Variable B² | CR | FC | CR | FC | CR | FC |
| 43 | 2/25 | Control | +0.050% bisulfite | 1:1.92 | 1:1.5 | 1:1.76 | 1:1.5 | 1:2.1 | 1:1.5 |
| 44 | 2/25 | Control | +0.100% bisulfite | 1:1.45 | 1:1.75 | 1:1.21 | 1:7 | 1:1.74 | 1:1 |
| 45 | 2/25 | Control | +0.125% bisulfite | 1:2.01 | 1:3.33 | 1:1.83 | 1:5 | 1:2.2 | 1:2.5 |
| 46 | 2/23 | Control | +0.150% bisulfite | 1:1.8 | 1:1.83 | 1:1.97 | 1:6 | 1:1.65 | 2.25:1 |

¹Variable-A: Control Cat Base
²Variable-B: Control Cat Base + bisulfite

The kibble samples used in Examples 43-46 were initially analyzed for moisture, protein, fat, ash, and PV. The results of these analyses are set out in Table 10:

TABLE 10
Proximate analyses for Examples 43-46

| | Example | | | | |
|---|---|---|---|---|---|
| | Control | 43 | 44 | 45 | 46 |
| Base/ | 0% | +0.050% | +0.100% | +0.125% | +0.150% |
| % Bisulfite | | | | | |
| Moisture (%) | 7.48 | 3.96 | 6.15 | 8.64 | 7.26 |
| Protein (%) | 35.4 | 38.2 | 34.8 | 34.8 | 35.0 |
| Fat (%) | 6.25 | 6.73 | 6.05 | 6.21 | 6.31 |
| Ash (%) | 5.25 | 5.25 | 5.36 | 5.31 | 5.34 |
| PV (meq/kf | 10.7 | 9.74 | 5.53 | 4.71 | 8.37 |
| fat) | | | | | |

Aldehyde levels of the samples used in Examples 43-46 were also studied. Results for treatment with bisulfite versus the control are shown in Table 11:

TABLE 11
Effect of different NaHSO₃ treatments on level
of oxidative aldehydes in cat kibble

| | Example | | | | |
|---|---|---|---|---|---|
| | Control | 43 | 44 | 45 | 46 |
| Base + | 0% | +0.050% | +0.100% | +0.125% | +0.150% |
| Bisulfite | | | | | |
| Components | | | | | |
| Hexanal | 2.628 | 2.18 | 1.002 | 1.560 | 1.372 |
| Butanal | — | — | — | — | — |
| Pentanal | 0.244 | 0.212 | 0.058 | 0.124 | 0.112 |
| Heptanal | 0.236 | 0.212 | 0.088 | 0.128 | 0.112 |
| Octanal | 0.150 | 0.130 | 0.064 | 0.082 | 0.064 |
| Nonanal | 0.286 | 0.228 | 0.178 | 0.172 | 0.118 |

¹I.S. = Internal Standard (6-Methyl-5-hepten-2-one)

### Examples 47-52

### Cat Palatability Testing of Stored Samples Using Various Flavors

The cat base used in Examples 43-46 was formulated with various flavors, stored for 3 months, and then subjected to additional palatability testing. The results are shown in Table 12:

TABLE 12
Palatability of stored samples

| | Days/ | Variable | Variable | Average- | Average- | Day-1 | Day-1 | Day-2 | Day-2 |
|---|---|---|---|---|---|---|---|---|---|
| Example | Cats | A¹ | B² | CR | FC | CR | FC | CR | FC |
| 47 | 2/24 | Control | +0.075% bisulfite | 1.01:1 | 1:1.05 | 1:1.28 | 1:1.44 | 1.31:1 | 1.33:1 |
| 48 | 2/22 | Control | +0.075% bisulfite | 1:1 | 1:1.69 | 1.37:1 | 1:3.4 | 1.38:1 | 1.1:1 |
| 49 | 2/25 | Control | +0.100% bisulfite | 1.06:1 | 1:1.28 | 1.09:1 | 1:1.5 | 1.04:1 | 1:1.1 |
| 50 | 2/25 | Control | +0.100% bisulfite | 1:1.13 | 1:1.1 | 1.04:1 | 1:1.3 | 1:1.33 | 1.11:1 |
| 51 | 2/24 | Control | +0.075% bisulfite | 1.73:1 | 1.19:1 | 1.52:1 | 1.09:1 | 1.97:1 | 1.3:1 |
| 52 | 2/25 | Control | +0.100% bisulfite | 1.68:1 | 1.25:1 | 1.78:1 | 1.44:1 | 1.59:1 | 1.09:1 |

¹Variable-A: Control Cat Base
²Variable-B: Control Cat Base + bisulfite

### Examples: 53-55

### Cat Palatability Testing of Stored Samples Containing Sodium Sulfite

The cat base used in Examples 55-55 was formulated with various flavors and slightly aged. The flavorant of Example 54 also included sodium sulfite. The results are shown in Table 13:

TABLE 13
Palatability of stored samples

| | Days/ | Variable | Variable | Average- | Average- | Day-1 | Day-1 | Day-2 | Day-2 |
|---|---|---|---|---|---|---|---|---|---|
| Example | Cats | A¹ | B² | CR | FC | CR | FC | CR | FC |
| 53 | 2/22 | Control + 10% | +0.075% | 1.12:1 | 1.31:1 | 1:1.07 | 1:1.5 | 1.34:1 | 3.25:1 |
| | | TPF + 1.5% | bisulfite + | | | | | | |
| | | F1610 | 10% TPF + | | | | | | |
| | | | 1.5% F1610 | | | | | | |
| 54 | 2/25 | Control + 10% | +0.075% | 1:1.27 | 1:1.21 | 1:1.75 | 1:2.5 | 1.07:1 | 1.63:1 |
| | | TPF + 1.5% | bisulfite + | sig | | sig | | | |
| | | F1R04H01 | 10% TPF + | | | | | | |
| | | (F1610w/0.12% | 1.5% F1R04H01 | | | | | | |
| | | Na sulfite) | (F1610w/0.12% | | | | | | |
| | | | Na sulfite) | | | | | | |
| 55 | 2/25 | Control + 10% | +0.075% | 1:3.04 | 1:1.93 | 1:2.56 | 1:2.14 | 1:3.66 | 1:1.75 |
| | | TPF + 1.5% | bisulfite + | sig | | sig | | sig | |
| | | I1R04H01 | 10% TPF + | | | | | | |
| | | (C1102) | 1.5% I1R04H01 | | | | | | |
| | | | (C1102) | | | | | | |

The foregoing demonstrates the positive results obtained with surface application of various concentrations of bisulfite to kibble. The bisulfite was also found to extend product shelf-life. Positive results are also obtained by blending dry metabisulfite with other dry kibble ingredients prior to cooking-extrusion of kibble.

### Examples 56-64

### Cat Palatability Testing of Loaf (can) Products Treated with Bisulfite

Loaf and formed canned cat food products were prepared in a commercial production facility by a continuous submerged hydrostat process at temperatures and pressures sufficient to cook and sterilize the products in order to prepare, on a commercial scale, typical canned cat food products.

A bisulfite composition containing 2% by weight sodium metabisulfite was sent to a cat food manufacturer for testing. Commercial moist cat food formulations were treated with varying amounts of the bisulfite composition and evaluated with cats by the cat food manufacturer. The treated compositions were either at parity with or preferred over the control sample, which contained none of the bisulfite composition. The results are set out in Table 14:

TABLE 14
Commercial moist cat food treated with bisulfite

| | CONTROL | TREATED | |
|---|---|---|---|
| EXAMPLE | SAMPLE | SAMPLE | PREFERENCE |
| 56 | 3 oz | 3 oz | Treated Sample |
| | Gourmet Chicken | Gourmet Chicken, | |
| | | 0.9% bisulfite | |
| | | composition | |
| 57 | 3 oz | 3 oz | Treated Sample |
| | Gourmet Chicken | Gourmet Chicken, | |
| | | 1.25% bisulfite | |
| | | composition | |
| 58 | 3 oz | 3 oz | Treated Sample |
| | Gourmet Chicken | Gourmet Chicken, | |
| | | 1.69% bisulfite | |
| | | composition | |
| 59 | 3 oz | 3 oz | No preference |
| | Gourmet Chicken | Gourmet Chicken, | |
| | (formulated using | (formulated using | |
| | chicken liver) | chicken liver) | |
| | | 0.6% bisulfite | |
| | | composition | |
| 60 | 3 oz | 3 oz | No preference |
| | Gourmet Chicken | Gourmet Chicken, | |
| | (formulated using | (formulated using | |
| | chicken liver) | chicken liver) | |
| | | 0.9% bisulfite | |
| | | composition | |
| 61 | 3 oz | 3 oz | Treated Sample |
| | Gourmet Chicken | Gourmet Chicken, | |
| | (formulated using | (formulated using | |
| | chicken liver) | chicken liver) | |
| | | 1.7% bisulfite | |
| | | composition | |
| 62 | 3 oz | 3 oz | Treated Sample |
| | Gourmet Chicken | Gourmet Chicken, | |
| | (formulated using | (formulated using | |
| | chicken liver) | chicken liver) | |
| | | 2.0% bisulfite | |
| | | composition | |
| 63 | 3 oz | 3 oz | Treated Sample |
| | Gourmet Chicken | Gourmet Chicken, | |
| | (formulated using | (formulated using | |
| | chicken liver) | chicken liver) | |
| | | 2.7% bisulfite | |
| | | composition | |
| 64 | 3 oz | 3 oz | Treated Sample |
| | Gourmet Chicken | Gourmet Chicken, | |
| | (formulated using | 0.9% bisulfite | |
| | chicken liver) | composition | |

### Examples: 65-69

### High Moisture Study of Bisulfite Modified Kibble

During an extrusion trial for dog kibble, several samples of bisulfite modified kibble were collected at the extruder stage. The samples were kept in airtight containers at room temperature for about 5 months. After 5 months, a visual inspection of samples revealed that several samples had not developed mold because their containers remained airtight for the entire 5 month period. This result may be contributed to by the reductive environment created by residual unreacted bisulfite. These non-moldy samples were tested for moisture content and water activity. The addition of bisulfite preserved high moisture samples in airtight containers from mold growth under the conditions set out in Table 15:

TABLE 15
High moisture analysis

| | | MOISTURE | WATER |
|---|---|---|---|
| EXAMPLE | SAMPLE | CONTENT | ACTIVITY LEVEL |
| 65 | 300 ppm bisulfite | 27.80% | 0.945 |
| | Liquid addition | | |
| 66 | 300 ppm bisulfite | 26.20% | 0.937 |
| | Liquid addition | | |
| 67 | 500 ppm bisulfite | 26.60% | 0.939 |
| | Liquid addition | | |
| 68 | 500 ppm bisulfite | 27.20% | 0.937 |
| | Liquid addition | | |
| 69 | 750 ppm bisulfite | 28.30% | 0.940 |
| | Liquid addition | | |

From the preceding description of various embodiments of the present invention, it is evident that the objects of the invention are attained. Although the invention has been described and illustrated in detail, it is to be clearly understood that the same is intended by way of illustration and example only and is not to be taken by way of limitation. Accordingly, the spirit and scope of the invention are to be limited only by the terms of the appended claims.

What is claimed:

1. A method for improving the palatability of a livestock feed or companion animal food product comprising a basal composition containing unsaturated fatty acids that oxidize to form aldehydes or ketones, said method comprising contacting said basal composition with a source of bisulfite anions so that any aldehydes or ketones present form organosulfite salts.

2. The method of claim 1, wherein said source of bisulfite anions is a metabisulfite species.

3. The method of claim 1, wherein said source of bisulfite anions is an aqueous solution of hydrated bisulfite.

4. The method of claim 3, wherein said aqueous bisulfite solution is an aqueous solution of ammonium metabisulfite or alkali metal bisulfite.

5. The method of claim 4, wherein said alkali metal bisulfite is sodium or potassium bisulfite.

6. The method of claim 3, wherein the bisulfite anion concentration in said aqueous solution is between about 0.0001 and about 20% by weight.

7. The method of claim 1, wherein said basal composition is extruded to form a dry or semi-dry kibble and is contacted with said bisulfite anion source before being extruded.

8. The method of claim 1, wherein said basal composition is extruded to form a dry or semi-dry kibble and said bisulfite anion source is applied to the surface of said kibble after it is extruded

9. The method of claim 1, further comprising the step of applying a palatability enhancing composition to the surface of said kibble after it is extruded.

10. A method for improving the palatability of a cooked moist companion animal food product comprising a feed- or food-grade raw material containing unsaturated fatty acids that oxidize to form aldehydes or ketones, said method comprising contacting said food product with a source of bisulfite anions so that any aldehydes or ketones present form organosulfite salts.

11. The method of claim 10, wherein said food product is contacted with said source of bisulfite anions prior to cooking.

12. The method of claim 10, wherein said source of bisulfite anions is contacted with said food product prior to cooking by contacting said anion source with said raw material before adding said raw material to said food product.

13. The method of claim 10, wherein said source of bisulfite anions is a metabisulfite species.

14. The method of claim 10, wherein said source of bisulfite anions is an aqueous solution of hydrated bisulfite.

15. The method of claim 14, wherein said aqueous bisulfite solution is an aqueous solution of alkali metal bisulfite.

16. The method of claim 15, wherein said alkali metal bisulfite is sodium or potassium bisulfite.

17. The method of claim 10, wherein said food product further comprises a palatability enhancing composition.

18. The method of claim 17, wherein said palatability enhancing composition comprises a palatability enhancing quantity of one or more compounds selected from the group consisting of pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid and hexamic acid salts.

19. The method of claim 9, wherein said palatability enhancing composition comprises a palatability enhancing quantity of one or more compounds selected from the group consisting of pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid and hexamic acid salts.

20. The method of claim 3, wherein said contacting step comprises contacting said feed or food product with said aqueous bisulfite solution so that any aldehydes or ketones present form water-soluble organosulfite salts that dissolve in the aqueous solution, and said method further comprises the step of separating said feed or food product from said solution.

21. The method of claim 20, further comprising the step of repeating said contacting step after said feed or food product is separated from said aqueous solution.

22. The method of claim 20, further comprising the step of washing said feed or food product one or more times with water after said feed or food product is separated from said aqueous solution.

23. The method of claim 20, further comprising the step of acidifying said aqueous solution after said feed or food product is separated therefrom to convert any organosulfite salt back to the corresponding aldehyde or ketone and regenerate said bisulfite solution.

24. The method of claim 23, further comprising the step of separating any aldehyde or ketone present from said aqueous solution.

25. The method of claim 23, further comprising the step of contacting the regenerated bisulfite solution with the same quantity or a different quantity of feed or food product containing oxidized fatty acids.

26. The method of claim 1 or claim 10, further comprising the step of adding an effective amount of a feed- or food-grade antioxidant to said feed or food product.

27. The method of claim 26, wherein said antioxidant is selected from the group consisting of ethoxyquin, BHA, BHT, propyl gallate, tocopherols and rosemary extracts.

28. The method of claim 26, wherein said antioxidant is added in an amount effective to provide an anti-oxidant level between about 0.01 and about 1000 ppm in the feed or food product.

29. The method of claim 1, wherein said feed or food product comprises a feed- or food-grade raw meat or meat by-product containing said unsaturated fatty acids.

30. The method of claim 10, wherein said feed- or food-grade raw material is a meat or meat by-product

31. The method of claim 29 or claim 30, wherein said meat or meat by-product is selected from the group consisting of meat and meat by-products derived from beef, pork, sheep, lamb, poultry, duck, tuna, salmon, cod, whitefish and shrimp.

32. The method of claim 1, wherein said feed- or food product comprises an animal or vegetable fat or oil containing said unsaturated fatty acids.

33. The method of claim 10, wherein said feed- or food-grade raw material is an animal or vegetable fat or oil.

34. The method of claim 1, wherein said method is a batch process.

35. The method of claim 1, wherein said method is a continuous process.

36. The method of claim 32 or claim 33 wherein said animal fat is applied to said product in admixture with said source of bisulfite anions.

37. A kit comprising separate containers of a feed- or food-grade antioxidant and a metabisulfite species or an aqueous bisulfite solution.

38. The kit of claim 37, further comprising a third separate container of a palatability enhancing composition.

39. An extruded livestock feed or companion animal food composition prepared from a basal composition containing unsaturated fatty acids that oxidize to form aldehydes or ketones mixed prior to extrusion with a source of bisulfite anions.

40. An extruded livestock feed or companion animal food composition prepared from a basal composition containing unsaturated fatty acids that oxidize to form aldehydes or ketones coated after extrusion with a source of bisulfite anions.

41. The feed or food composition of claim 39 or claim 40, wherein said source of bisulfite anions is a metabisulfite species.

42. The feed or food composition of claim 39 or claim 40, wherein said source of bisulfite anions is an aqueous solution of hydrated bisulfite.

43. The feed or food composition of claim 42, wherein said aqueous bisulfite solution is an aqueous solution of alkali metal bisulfite.

44. The feed or food composition of claim 43, wherein said alkali metal bisulfite is sodium or potassium bisulfite.

45. The feed or food composition of claim 39 or claim 40, wherein said basal composition is coated after extrusion with a palatability enhancing composition.

46. The feed or food composition of claim 45, wherein said palatability enhancing composition comprises a palatability enhancing quantity of one or more compounds selected from the group consisting of pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid and hexamic acid salts.

47. The feed or food composition of claim 39 or claim 40, further comprising an effective amount of a feed- or food-grade antioxidant.

48. The feed or food composition of claim 47, wherein said antioxidant is selected from the group consisting of ethoxyquin, BHA, BHT, propyl gallate, tocopherols and rosemary extracts.

49. The feed or food composition of claim 47, wherein said antioxidant is present in an amount between about 0.01 and about 1000 ppm.

50. The feed or food composition of claim 39 or claim 40, characterized in that said basal composition comprises a feed- or food-grade raw meat or meat byproduct containing said unsaturated fatty acids.

51. The feed or food composition of claim 50, wherein said meat or meat by-product is selected from the group consisting of meat and meat by-products derived from beef, pork, sheep, lamb, poultry, duck, tuna, salmon, cod, whitefish and shrimp.

52. The feed or food composition of claim 39 or claim 40, characterized in that said basal composition comprises an animal or vegetable fat or oil containing said unsaturated fatty acids.

53. A moist cooked companion animal food composition prepared from a raw material containing unsaturated fatty acids that oxidize to form aldehydes and ketones, wherein said food composition is contacted prior to cooking with a source of bisulfite anions.

54. The food composition of claim 53, wherein said food composition is contacted with said bisulfite solution prior to cooking by contacting said raw material with said bisulfite solution before adding said raw material to said food composition.

55. The food composition of claim 53, wherein said source of bisulfite anions is a metabisulfite species.

56. The food composition of claim 53, wherein said source of bisulfite anions is an aqueous solution of hydrated bisulfite.

57. The food composition of claim 56, wherein said aqueous bisulfite solution is an aqueous solution of alkali metal bisulfite.

58. The food composition of claim 57, wherein said alkali metal bisulfite is sodium or potassium bisulfite.

59. The food composition of claim 53, further comprising a palatability enhancing composition.

60. The food composition of claim 59, wherein said palatability enhancing composition comprises a palatability enhancing quantity of one or more compounds selected from the group consisting of pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid and hexamic acid salts.

61. The food composition of claim 53, further comprising an effective amount of an antioxidant.

62. The food composition of claim 61, wherein said antioxidant is selected from the group consisting of ethoxyquin, BHA, BHT, propyl gallate, tocopherols and rosemary extracts.

63. The food composition of claim 61, wherein said antioxidant is present in an amount between about 0.01 and about 1000 ppm.

64. The food composition of claim 53, characterized in that said raw material comprises a raw meat or meat byproduct containing said unsaturated fatty acids.

65. The food composition of claim 64, wherein said meat or meat by-product is selected from the group consisting of meat and meat by-products derived from beef, pork, sheep, lamb, poultry, duck, tuna, salmon, cod, whitefish and shrimp.

66. The food composition of claim 53, characterized in that said raw material comprises an animal or vegetable fat or oil containing said unsaturated fatty acids.

67. The feed or food composition of claim 40, wherein said food composition is coated after extrusion with a source of bisulfite anions in admixture with animal fat.

68. A palatability enhancing composition for extruded pet food, said composition comprising at least one palatability enhancing compound in an amount effective to enhance palatability, from about 0.01 to about 20% by weight of a source of bisulfite anions and at least one ingredient selected from the group consisting of meat products, meat by-products, fish products, fish by-products, dairy products, dairy by-products, sources of microbial proteins, vegetable proteins, carbohydrates and amino acids.

69. The composition of claim 68, wherein said palatability enhancing compound is selected from the group consisting of pyrophosphoric acid, polyphosphoric acid salts, phosphoric acid, phosphoric acid salts, acid tripolyphosphate, tripolyphosphate salts, acid hexapolyphosphate, hexapolyphosphate salts, citric acid, citric acid salts, tartaric acid, tartaric acid salts, fumaric acid, fumaric acid salts, lactic acid, lactic acid salts, acetic acid, acetic acid salts, formic acid, formic acid salts, hexamic acid and hexamic acid salts.

70. The composition of claim 68, comprising from about 0.1 to about 80% by weight of at least one palatability enhancing compound.

71. The composition of claim 68, wherein said composition is dry and said source of bisulfite anions is a metabisulfite species.

72. The composition of claim 68, wherein said composition I liquid and said source of bisulfite anions is an aqueous solution of bisulfite.

73. The composition of claim 72, wherein said aqueous bisulfite solution is an aqueous solution of alkali metal bisulfite.

74. The composition of claim 73, wherein said alkali metal bisulfite is sodium or potassium bisulfite.

75. The composition of claim 68, further comprising an effective amount of an antioxidant.

76. The composition of claim 75, wherein said antioxidant is selected from the group consisting of ethoxyquin, BHA, BHT, propyl gallate, tocopherols and rosemary extracts.
